(19) United States
(12) Patent Application Publication
(10) Pub. No.: US 2016/0107360 A1
(43) Pub. Date: Apr. 21, 2016

(54) PROCESSES FOR PROVIDING CONTROLLED DENSITY ARTICLES

(71) Applicant: Bowdie Isanhart, Coleman, MI (US)

(72) Inventor: Bowdie Isanhart, Coleman, MI (US)

(21) Appl. No.: 14/886,548

(22) Filed: Oct. 19, 2015

Related U.S. Application Data
(60) Provisional application No. 62/066,411, filed on Oct. 21, 2014.

(51) Int. Cl. B29C 47/00; C08J 9/16; B29C 44/20

(52) U.S. Cl. CPC B29C 47/0042; B29C 44/20; B29C 47/0066; C08J 9/16; C08J 2375/04

(57) ABSTRACT

An extrusion process or providing controlled density articles that have integral skins formed thereon.

This application claims priority from U.S. Provisional application Ser. No. 62/066,411, filed Oct. 21, 2014.

### BACKGROUND OF THE DISCLOSURE

This disclosure deals with an extrusion process for providing controlled density articles. Prior art methods that the inventor is aware of for providing controlled density articles can be found in U.S. Pat. No. 4,990,542, that issued Feb. 5, 1991 to Motani et al in which an extruded synthetic resin foam comprising a cell structure of substantially two different cell sizes wherein the cells are dispersed in an “island in the sea manner”. The foam is produced by forming a mixture of synthetic resin, a fine mineral powder having hydroxyl groups, and a cell controlling agent, incorporating a volatile foaming agent and extruding the mixture to form the foam. This process deals with a single extruder.

A second patent to Motani, et al is U.S. Pat. No. 5,064,874, that issued Nov. 12, 1991 which is a divisional patent application from the aforementioned U.S. patent and therefore discloses the same information.

Hills, in U.S. Pat. No. 5,162,074 that issued Nov. 10, 1992 deals with a method for extruding a wide variety of plural component fiber configurations in a spin pack utilizing one or more disposable distributor plates. The essence of that invention is the die in which distributor flow patterns are etched to provide multiple discrete polymer component streams which blend in the final product.

An additional patent issuing to Hills on Nov. 14, 1995 deals with exactly the same subject matter.

EP patent 1979401 describes how to make TPU foam by injecting gas into a polymer melt and forming beads/pellets under pressure to make an expandable bead. The bead is eventually expanded.

The following link discloses how to make polymers heat up when exposed to microwaves,
http://books.google.com/books?id=dnZL36Nw1ToC&pg=PA180&1pg=PA180&dg=po lymers+not+transparent+to+microwave&source=b1&ots=6iEOVqmZTS&sig=RuwBK pKV9yzDBENq1DmrYT2qyyQ&h1=en&sa=X&ei=9hn1U8S5HtGLyASFr4DQDQ&ved=0CDMQ6 AEwBg#v=onepage&q=polymers%20not%20transparent%20to20microwave&f=fals e

A similar method of making these types of structures is described in U.S. Patent publication 20010013668 A1 for making multi-layered films. The structure of the film can be similar to some of the multi component structures except it is in sheet or film, form instead of fibers.

Winstead, in U.S. Pat. No. 3,461,496 discloses an apparatus for extruding a sheet of foamed thermoplastic material having an expanded, cellular, inner structure and a thin, unexpended, molecularly integrated skin of the same material covering at least one side.

### THE DISCLOSURE

In one embodiment, there is a process for providing controlled density articles. The process comprises providing an extruder having a predetermined die head attached to it. Thereafter, providing a predetermined polymer in the extruder and providing a gas source wherein the gas source is connected directly to the die head.

Then, extruding the polymer through the extruder and simultaneously delivering the gas to the die head while by-passing the extruder with the gas.

The extruded polymer is passed through a forming device to periodically crimp the extruded polymer and form an extrudate consisting of individual particles.

In a second embodiment, there is a process for providing controlled density articles, the process comprising providing a first extruder having a predetermined die head attached to it. Thereafter, providing at least a second extruder and providing a predetermined first polymer in the first extruder, then, providing a predetermined second polymer in the second extruder and providing a gas source wherein the gas source is connected directly to the second extruder.

Then, extruding the first polymer through the first extruder and, simultaneously with extrusion through the first extruder, extruding the second. Polymer through the second extruder and delivering the gas to the die head through the second extruder.

The extruded polymer is passed through a forming device to periodically crimp the extruded polymer and form an extrudate consisting of individual particles.

A third embodiment provides a process for providing controlled density articles, the process comprising providing a first extruder having a predetermined die head attached to it.

Providing at least a second extruder and providing a predetermined first polymer in the first extruder. Also providing a predetermined second polymer in the second extruder and providing a gas source wherein the gas source is connected directly to the die head.

Extruding the first polymer through the first extruder simultaneously with extrusion through the first extruder and extruding the second polymer through the second extruder, and, simultaneously with the extrusion through the first and the second extruders, delivering the gas to the die head while by-passing both the first extruder and the second extruder.

The extruded polymer is passed through a forming device to periodically crimp the extruded polymer and form an extrudate consisting of individual particles.

Further, there are products produced by the processes as disclosed just Supra.

In another embodiment, there is a process for providing controlled density articles. The process comprises providing an extruder having a predetermined die head attached to it. A predetermined polymer is passed through the extruder and simultaneously with extruding the polymer, providing a gas source wherein the gas source is connected directly to the extruder or die head. There is a forming device to crimp the extruded polymer and form an extrudate consisting of individual particles, contained in the die head.

### BRIEF DESCRIPTION OF THE DRAWINGS

FIG. 1 is an illustration of a piece of equipment that accepts the extrudate and forms individual particles from the extrudate, for example, pellets.

FIG. 2 is an illustration of the illustration of FIG. 1, showing additional cutting knives for separating the individual particles, for example, pellets.

FIG. 3 is an illustration of a forming device incorporated into a die head.

### DETAILED DISCLOSURE

This disclosure has the following objects and advantages over the prior art. The existing technologies use gas dissolved in a single grade of polymer formed into particles under pressure to make an unexpended polymer particle, (also called an expandable particle). To expand the particle, steam is contacted with the particle, often in a closed mold. The steam softens the polymer and allows the pressure inside the particle to expand the particle. Steam can damage some polymers and foaming can decrease the properties of the polymer if the foam cells breach the surface of the particle. Other methods are known for expanding such particles, such as any means of heating the particle end sound, for example.

The processes disclosed herein allow for making a thermoplastic polyurethane (TPU), or other thermoplastic, expanded or unexpanded particle that can have properties from more than one material; limits the risk of foam cells breaching the surface of the particle, and can expand the particles without damaging the chemistry of the raw material, such as TPU, via hydrolysis of the TPU polymer chain.

Through the use of core sheath technology, “islands in the sea” technologies and similarly formed multi-component fiber techniques one can make a structure that has a polymeric structure on the outside and a different composition on the inside, including other polymers and or expandable gases/foaming agents, with other properties.

Some layered structures can be made where both materials are exposed to the surface. This may be beneficial where multi-material properties can be beneficial, for example two different coefficient of friction materials for multi-surface foot wear applications or wet/dry on the same surface.

The multi-component structure is made by a “pack” similar to those described by the Hills reference.

The raw polymers are fed into the pack via one or more extruders. Extruders are common to the plastics field and can be single or multiple screw extruders or planetary units, plunger feeding extruders, etc.

If TPU is the desired outer material, then no foaming agent should be applied. In the extruder that feeds the TPU to the “pack” contrary to that taught in the prior art. Foaming agents should be supplied to the “pack” via a gas supply pump, a second extruder system, or dissolved or contained in a second polymer system that results in the inside of the outer layer of TPU. A melt pump between the extruder and the “pack” may be required, depending on polymer properties, to keep the pressurized gas or foaming agent from backing up into the extruder and out the extruder feed port(s).

Typical gases used as foaming agents are carbon dioxide (CO₂) and Nitrogen. Some other liquefied gases are used as blowing agents such as isopentane, butane, and refrigerants such as CFC's. Other blowing agents generate gas during a chemical reaction that occurs in the extruder, such as sodium bicarbonate, azodicarbonamide and other endothermic and exothermic chemical blowing or foaming agents. Pressurized hollow micro spheres, such as those manufactured by Akzo-Noble (Expancel®) and similar expandable spheres can be used as blowing agents also.

The inside materials, core of a core/sheath structure, islands in an “islands in the sea” structure or similar interior or alternating layer structure as described by Hills and others, can be a pressurized gas that will act as a foaming agent when pressure is removed from the gas. There can also be a second polymer that contains a blowing agent or expandable gas. It is also possible, and in some cases, desired to make a multi-material inside structure where a component or layer is a polymer containing or not containing a foaming agent or compressed gas and another area or layer inside the structure is a pressurized gas or foaming agent.

As an inside material, a second pressurized supply of the same grade as the outer un-pressurized supply or a second grade of polymer, different than the outer layer, could be used with a foaming agent or pressurized gas dissolved in the polymer of the inner layer. Once outer and inner materials come together in the ‘pack’ they exit the die and if not kept under pressure the foaming agent(s), or dissolved pressurized gas(s), or areas of free pressurized gas, will expand due to lack of pressure, previously provided by the extruder/pump/die/Pack systems.

If an unexpanded structure is required, a pellet form is often desirable. The structure must be kept under pressure until the polymers solidify enough to provide pressure that will keep the structure from expanding. This expansion is the foaming process. Unexpanded structures that have areas or layers of free pressurized, non-dissolved gas may become compressed and even dissolve into the surrounding polymers depending on the pressures involved in the cooling process.

Methods for keeping the structure unexpended are: underwater/under fluid pelletizing systems that provide pressure to the structure as well as a cooling and or curing and or crystallizing medium; a pressurized/fixed distance solid surface that keeps the structure from expanding while it cools, such as a caterpillar die. The solid surface device can also provide liquid or gas flow over the die for cooling, through the die for cooling.

The process allows for the formation of composite foams. One can get the benefits of different polymers in one structure without having to laminate while reducing the density of the composite, for example, a TPU outer layer for abrasion resistance and foamed co-polyester elastomer on the inside for flex fatigue resistance. Typical inner polymer materials that could be used are: EVA, EPS, COPE, COPA, styrenic block copolymers, and TPE's. To be able to activate or expand an expandable pellet steam can be applied but if a microwave absorbing particle, such as aluminum flakes, or other microwave absorbing materials, typically metals, are incorporated into the structure the structure can be heated and expanded without damaging hydrolysis sensitive materials like TPU. The temperature of the structure can be controlled to allow for minimal melting and cohesive bonding of the expanded particles. Expandable particles will need to be much larger than those typically made by the micro-component fiber industry. Images for some possible structures can be found in Table I.

Many of the problems associated with providing particles of various materials by prior art methods is the fact that upon extrusion, prior art processes merely cut or pelletize the extrudate. This means of providing particles leaves two open ends on the particles, which means that the covering material of the extrudate or the outer skin Is not generally present on the cut ends.

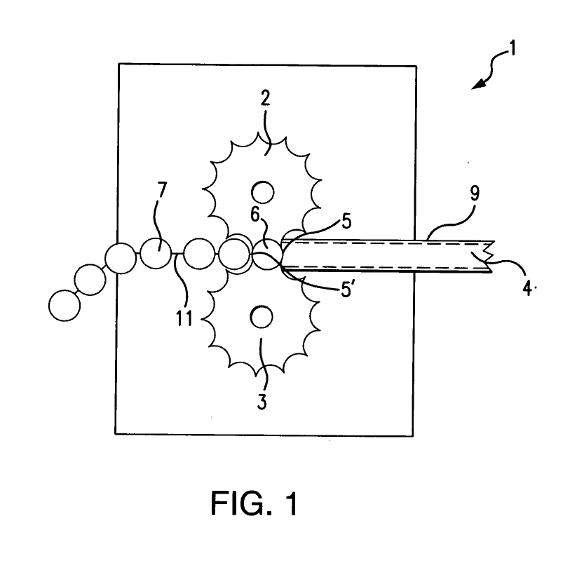

The method of the instant invention provides extrudates 4 that are crimped (points 5 and 5′) as it leaves the extruder (not shown) and the pelletizer is a forming device 1 as shown in FIG. 1, in which two wheels are shown, an upper wheel 2, and a lower or base wheel 3. These wheels 2 and 3 are synchronized such that when they come together at the interface of the two wheels (5 and 5′), they form a small cup 6, while at the same time, crimping the extrudate. This means provides pellets 7 that are essentially covered by the outer skin 9 of the extrudates in phantom). FIG. 1 shows the pellets 7 as individual pellets, but they are still tied together in a ribbon 11 as they leave the crimping apparatus.

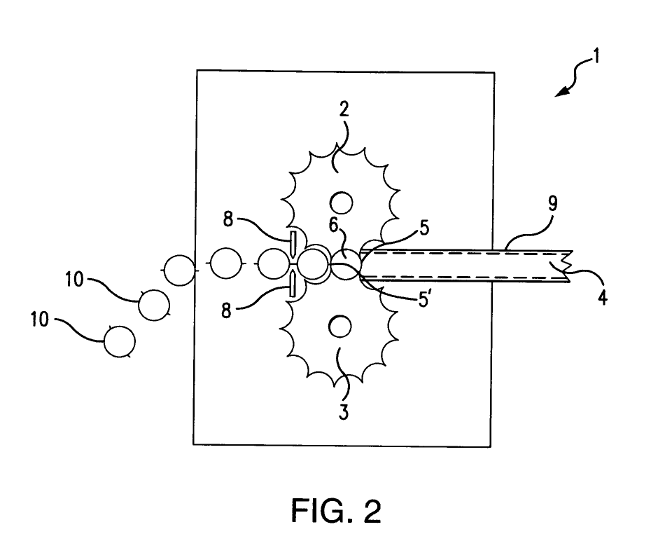

FIG. 2, in which like numbers designate like components, shows the same apparatus as is shown in FIG. 1, except, it also shows a cutting knife 8 which separates the pellets 7 into individual pellets 10.

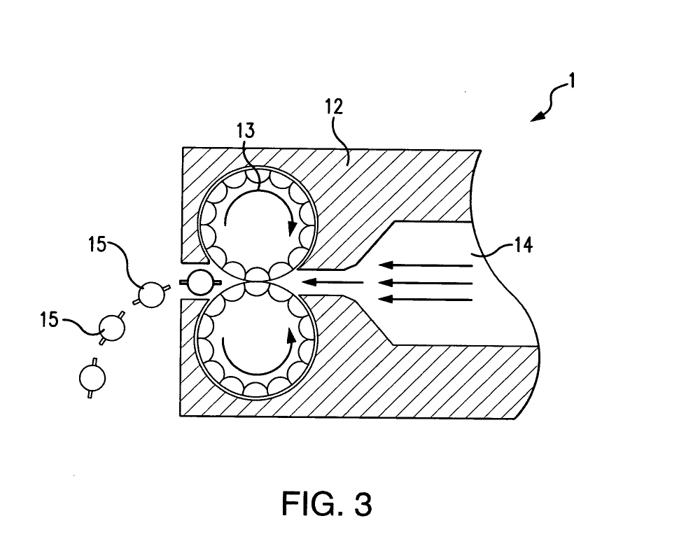

FIG. 3 shows a device that is incorporated into the die head for pelletization purposes wherein 12 is the die head, 13 is the palletization device, 14 is the extrudate in the die head 12 and 15 are the pellets or particles that are formed.

Extrudate has discreet boundaries between materials. Multi-materials means different materials. Two or more materials of the same chemistry but different densities due to foaming agents being added are considered to be two different materials due to the density. “Different” can refer to chemistry of the material as well. Extrudate is not considered to be a film or sheet and the width of extrudate is not more than 100 times the thickness of the extrudate. At least one of the materials has significantly less density than the others, i.e. an S₉ less than 0.9, preferably less than 0.5.

Location of the shaping device is always placed downstream from the extruder. Location downstream can be any useful location depending on the particle properties that are desired. Thermal properties of the material, external cooling, and foaming agents in the materials will determine where the shaping device should be located in the downstream process. If a pre-expanded particle is desired, the device will be located close to the extrusion die and large amount of cooling will be added to the system. The shaping device is made of high thermal conductivity material. If an expanded particle is desired, the device will be located further away from the extrusion die and the particle will be allowed to expand to a lower density range.

The device to shape the extrudate does the following: The shaping tool takes the extrudate and cups the material into a discreet shape, for example, a sphere. The shaping tool forms the outer surface of the extrudate such that it stretches and encapsulates the inner materials. The shaping tool can also separate the discreet particle from each other during or after forming by adding a cutting feature to the tool. The shaping tool can be made of different thermal conductivity materials to meet the needs of the application. The shaping tool should be made of a material, or coated with a material, such that the extrudate does not stick, that is, freely separates from the formed particle after forming.

Examples of shaping tools would be: a modified version of a strand pelletizer or a caterpillar puller. Both devices are well known to those skilled in the plastics processing and compounding industry.

What is claimed is:

1. A process for providing controlled density articles, said process comprising:
i. providing an extruder having a predetermined die head attached thereto;
ii. providing a predetermined polymer in the extruder;
iii. extruding said polymer through said extruder;
iv. simultaneously with extruding said polymer, providing a gas source wherein said gas source is connected directly to said extruder or die head;
v. passing said extruded polymer through a forming device to periodically crimp said extruded polymer and form an extrudate consisting of individual particles.

2. A process as claimed in 1 wherein said forming device also cuts and separates said individual particles.

3. A process for providing controlled density articles, said process comprising:
i. providing a first extruder having a predetermined die head attached thereto;
ii. providing at least a second extruder;
iii. providing a predetermined first polymer in the first extruder;
iv. providing a predetermined second polymer in the said at least second extruder;
vi. extruding said first polymer through said first extruder;
vii. providing a gas source wherein said gas source is connected directly to said at least second extruder or die head;
viii. simultaneously with extrusion through the first extruder, extruding said second polymer through said at least second extruder and delivering said gas to said die head through said at least said second extruder;
ix. passing said extruded polymer through a forming device to periodically crimp said extruded polymer and form an extrudate consisting of individual particles.

4. A process for providing controlled density articles, said process comprising:
i. providing a first extruder having a predetermined die head attached thereto;
ii. providing at least a second extruder;
iii. providing a predetermined first polymer in the first extruder;
iv. providing a predetermined second polymer in the at least said second extruder;
v. extruding said first polymer through said first extruder;
vi. simultaneously with extrusion through the first extruder, extruding said second polymer through said second extruder,
vii. providing a gas source wherein said gas source is connected directly to said die head;
viii. simultaneously with the extrusion through said first and said at least second extruders, delivering said gas to said die head while by-passing both the first extruder and said at least second extruder;
ix. passing said extruded polymer through a forming device to periodically crimp said extruded polymer and form an extrudate consisting of individual particles.

5. A process for providing controlled density articles, said process comprising:
i. providing an extruder having a predetermined die head attached thereto;
ii. providing a predetermined polymer in the extruder;
iii. extruding said polymer through said extruder;
iv. simultaneously with extruding said polymer, providing a gas source wherein said gas source is connected directly to said extruder or die head, and wherein, a forming device to periodically crimp said extruded polymer and form an extrudate consisting of individual particles, is contained in the die head.

6. A product when produced by the process as claimed in claim 1.

7. A product when produced by the process as claimed in claim 1.

8. A product when produced by the process as claimed in claim 4.
